(19) United States
(12) Patent Application Publication
(10) Pub. No.: US 2023/0186775 A1
(43) Pub. Date: Jun. 15, 2023

(54) STRUCTURAL INSPECTION USING FEEDBACK FROM ARTIFICIAL INTELLIGENCE SERVICES

(71) Applicant: International Business Machines Corporation, Armonk, NY (US)

(72) Inventors: Benjamin MANDLER, Zichron Yaakov (IL); Nili GUY, Haifa (IL); Samuel KALLNER, Menashe (IL); Maya BARNEA, Kiriat Bialik (IL); Ira ROSEN, Haifa (IL); Dmitri PIKUS, Haifa (IL); Gil SHARON, Haifa (IL); Netanel EDER, Tel-Mond (IL)

(21) Appl. No.: 17/550,808

(22) Filed: Dec. 14, 2021

(51) Int. Cl. G08G 5/00; B64C 39/02

(52) U.S. Cl. CPC G08G 5/003; G08G 5/0004; B64C 39/024; B64C 2201/12

(57) ABSTRACT

An example system includes a processor to receive target asset information from an asset management system. The processor can generate an inspection mission based on the target asset information. The processor can generate unmanned aerial vehicle (UAV)-specific commands based on the inspection mission. The processor can transmit the UAV-specific commands to an unmanned aerial vehicle (UAV) platform. The processor can receive images and sensor data from the UAV. The processor can also send the images and sensor data to an artificial intelligence (AI) services module. The processor can receive feedback from the AI services module. The processor can further modify the inspection mission based on the feedback.

### BACKGROUND

The present techniques relate to structural inspection. More specifically, the techniques relate to structural inspection using unmanned aerial vehicles (UAVs).

### SUMMARY

According to an embodiment described herein, a system can include processor to receive target asset information from an asset management system. The processor can also further generate an inspection mission based on the target asset information. The processor can generate unmanned aerial vehicle (UAV)-specific commands based on the inspection mission. The processor can also transmit the UAV-specific commands to an unmanned aerial vehicle (UAV) platform. The processor can receive images and sensor data from the UAV. The processor can send the images and sensor data to an artificial intelligence (AI) services module. The processor can receive feedback from the AI services module. The processor can then modify the inspection mission based on the feedback.

According to another embodiment described herein, a method can include receiving, via a processor, target asset information from an asset management system. The method can further include generating, via the processor, an inspection mission based on the target asset information. The method can further include generating unmanned aerial vehicle (UAV)-specific commands based on the inspection mission. The method can also further include transmitting, via the processor, the UAV-specific commands to an unmanned aerial vehicle (UAV) platform. The method can also include receiving, via the processor, images and sensor data from the UAV. The method can also further include sending, via the processor, the images and sensor data to an artificial intelligence (AI) services module. The method can also include receiving, via the processor, feedback from the AI services module. The method can further include modifying, via the processor, the inspection mission to generate updated commands based on the feedback.

According to another embodiment described herein, a computer program product for inspecting structures can include computer-readable storage medium having program code embodied therewith. The computer readable storage medium is not a transitory signal per se. The program code executable by a processor to cause the processor to receive target asset information from an asset management system. The program code can also cause the processor to generate an inspection mission based on the target asset information. The program code can also cause the processor to generate unmanned aerial vehicle (UAV)-specific commands based on the inspection mission. The program code can also cause the processor to transmit the UAV-specific commands to an unmanned aerial vehicle (UAV) platform. The program code can also cause the processor to receive images and sensor data from the UAV. The program code can also cause the processor to send the images and sensor data to an artificial intelligence (AI) services module. The program code can also cause the processor to also further receiving, via the processor, feedback from the AI services module. The program code can also cause the processor to modify, via the processor, the inspection mission to generate updated commands based on the feedback.

### BRIEF DESCRIPTION OF THE SEVERAL VIEWS OF THE DRAWINGS

FIG. 1 is a block diagram of an example system for automated inspection of structures with artificial intelligence (AI) feedback;

FIG. 2 is a process flow diagram of an example method that can generate and modify inspection missions based on AI feedback;

FIG. 3 is a process flow diagram of an example method that can generate commands for a UAV based on AI feedback;

FIG. 4 is a process flow diagram of an example method that can generate feedback based on images and data from a UAV;

FIG. 5 is a block diagram of an example computing device that can generate and modify inspection missions based on AI feedback;

FIG. 6 is a diagram of an example cloud computing environment according to embodiments described herein;

FIG. 7 is a diagram of an example abstraction model layers according to embodiments described herein; and

FIG. 8 is an example tangible, non-transitory computer-readable medium that can automatically inspect structures using a UAV with artificial intelligence (AI) feedback.

### DETAILED DESCRIPTION

Structures, such as bridges and buildings, are subject to wear and tear over time and may thus be inspected for various issues, such as cracks. Some methods include performing manual inspections of such infrastructure to identify potential issues that may need fixings. However, such manual solutions may be costly, complex, dangerous, and may take a long time. For example, manual inspections may be performed by humans who may tie themselves to the infrastructures physically and take photos and notes while hanging in the air. Moreover, such manual process is error prone, as inspectors perform manual inspections, taking pictures at various qualities using mobile phones, and documenting findings as they proceed with the inspection. In some instances, inspectors may not be able to inspect all parts of an infrastructure or miss potential issues due to human error.

Furthermore, automating such inspection is also prone to mistakes and other issues. As one example, images received from the use of remote imagery may be of poor quality. For example, the images may be too blurry, grainy, or out of focus to spot issues such as cracks. Moreover, the location of potential structural defects may not always be apparent in such images and may thus take substantial time to examine. In addition, automated methods such as the use of artificial intelligence (AI) analysis may also depend on image quality and thus produce poor outcomes based on low quality input. For example, in the case of a bridge, pictures taken may be difficult to analyze and localize on the bridge itself.

According to embodiments of the present disclosure, a system includes a processor to receive target asset information from an asset management system. The processor can generate an inspection mission based on the target asset information. The processor can generate unmanned aerial vehicle (UAV)-specific commands based on the inspection mission. The processor can transmit the UAV-specific commands to an unmanned aerial vehicle (UAV) platform. The processor can receive images and sensor data from the UAV. The processor can also send the images and sensor data to an artificial intelligence (AI) services module. The processor can receive feedback from the AI services module. The processor can further modify the inspection mission based on the feedback. Thus, embodiments of the present disclosure enable repeatable consistent UAV flights for taking pictures that AI models can handle well. The embodiments thus provide a faster, cheaper, safer, and more reliable and accurate system for inspection of structures to identify and locate defects, such as cracks, in structures. The embodiments thus provide an AI-based requirements flight of a UAV that can be combined with a dynamically generated path for the UAV for better overall structure inspection.

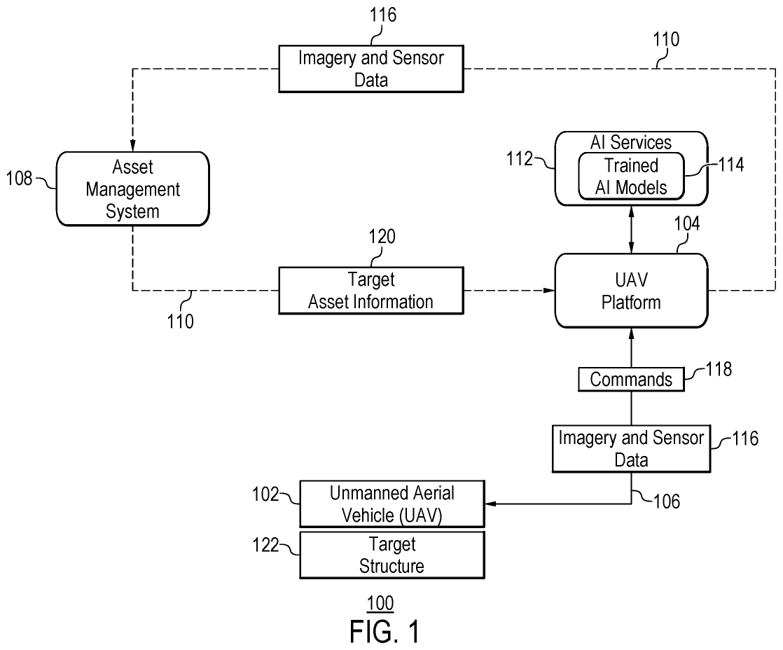

With reference now to FIG. 1, a block diagram shows an example system for automatically inspecting structures. The example system is generally referred to by the reference number 100. FIG. 1 includes an unmanned aerial vehicle (UAV) 102. For example, the UAV 102 may be equipped with a payload, including a camera and various sensors. The system 100 also includes a UAV platform 104 communicatively coupled to the UAV via a communication channel 106. For example, the UAV platform 104 may include a processor to execute various processes to control the UAV 102. In some examples, the UAV platform 104 may be partially implemented inside the UAV 102. The system 100 also includes an asset management system 108 communicatively coupled to the UAV platform 104 via a communication channel 110. For example, the communication channel may be any suitable wireless communication channel. In various examples, a portion or snapshot of the asset management system 108 may be implemented via a cloud computing solution, or via a stand-alone computing device. For example, the stand-alone computing device may be a device that is co-located with the UAV 102, such as in a computing device used by an operator of the UAV 102. In some examples, a snap shot or portion of the asset management system 108 may be collocated with the UAV 102. For example, the snap shot or portion of the asset management system 108 may be used by the UAV 102 in order to enable operation of the system 100 in the absence of network connectivity. The system 100 also further includes an AI services module 112. In some examples, the AI services module 112 may be implemented as a cloud service, as described herein. For example, the cloud-based AI services module 112 may detect defects in the structure, locate the defects, and generate three dimensional reconstructions of the structure with the defects. The AI services module 112 includes a set of trained AI models 114. In various examples, the AI models 114 may be any suitable machine learning model, or any other AI models. For example, the trained AI models 114 may have been trained to detect specific defects such as cracks and other structural defects in various structures. In some examples, the AI models 114 may also be trained to detect specific conditions, such as overgrowth or dirt, that may affect detection of defects. The system 100 also includes imagery and sensor data 116 shown being received at the UAV platform 104 from the UAV 102, and sent to the asset management system 108. The system also includes commands 118 shown being received by the UAV 102 from the UAV platform 104. For example, the commands 118 may be UAV specific commands. The system 100 also further includes target asset information 120 shown being sent from the asset management system 108 to the UAV platform 104.

In various examples, the AI service module 112 may be implemented in whole or in part in the UAV 102. In some examples, the AI service module 112 may be implemented in a computing device proximately co-located to the UAV 102. For example, a co-located AI services module 112 may be used to execute local AI computations. In various examples, local computations may include estimation of image quality and camera pose. For example, image quality may include analysis of focus or brightness. Camera pose estimation may include a determination as to whether the angle at which a picture is taken meets threshold criteria. As one example, local AI computations may include generation of feedback to modify one or more parameters of the UAV 102 in order improve image quality. In some examples, the AI services module 112 may be implemented using a cloud solution, as described herein. The UAV 102 is shown transmitting imagery and sensor data 116 and receiving commands 118 via the communication channel 106. For example, the communication channel 106 may be a wireless communication channel. The asset management system 108 is further shown sending a target asset information 120 to the UAV platform 104 via the communication channel 110. For example, the target asset information 120 may include information such as the geometry and IDs of assets and sub-assets to be inspected, such as a target structure 122. The system 100 thus further also includes the target structure 122 that is currently being inspected using the UAV 102. For example, the target structure 122 may be a building or a bridge being inspected for any number of defects.

In the example of FIG. 1, an end-to-end system 100 may include an asset management system 108 with dynamic automatically repeatable flights of a UAV 102, operating in conjunction with an AI services module 112, to achieve high quality inspection of infrastructure. In various examples, the generated flights may be AI requirement-based automatic UAV flights that are modified to improve imagery captured to comply with AI pipeline requirements. For example, the AI pipeline requirements may include overlap compliance between pictures, focus management, Ground Sample Distance (GSD) guarantee, and ensuring that way images are taken perpendicular to the scanned surface. In some examples, in response to detecting that some or all of the imagery and sensor data 116 does not meet AI pipeline requirements, the asset management system 108 can generate updated target asset information with a modified set of parameters. For example, the target asset information may be updated in response to an asset model change caused by a change in inspected object because of reconstruction, new trees in the area, or changes in power lines topology, among other causes. The target asset information details can enhance the respective information regarding assets with similar characteristics. In various examples, if the imagery and sensory data 116 result in all AI pipeline requirements being met, then the asset management system 108 can save the parameters used in the inspection mission as baseline parameters to be used in future missions for the target infrastructure 122, or similar structures. Thus, the system 100 may produce repeatable consistent flights for taking pictures that an associated AI model 114 can handle well. For example, the system 100 can perform additional inspection missions and accurately identify changes in the target infrastructure using identical baseline parameters. In some examples, the resulting imagery and sensor data 116 may enable the trained AI models 114 to detect changes in the size of cracks, or detect new cracks that may be close in proximity to other previously identified cracks.

Still referring to FIG. 1, an example process flow through the system 100 may start at an asset management system 108 requesting an inspection of a structure to be carried out by the UAV platform 104. In various examples, as a part of that inspection request, the asset management system 108 passes target asset information 120 pertinent to the creation of a flight mission. For example, the asset management system 108 may contains IDs of assets and sub-assets, that should be inspected during specific inspection mission. The asset management system 108 may contain a model for every asset and sub-asset. For example, each model may include a geometry of the asset or a corresponding bounding shape, and possibly surrounding objects and obstacles etc. In some examples, the target asset information 120 passed onto the UAV platform 104 may include the geometry or corresponding bounding shape of assets or sub-assets to be inspected, and any associated asset ID or sub-asset ID. In some examples, the asset ID, including sub-asset IDs for hierarchical structures, may traverse all parts of the system 100 such that the loop 110 can be closed at the end of the inspection process to associate the findings with the correct asset in the asset management system 108. The system 100 may thus perform fast, cheap, and accurate inspections of the recorded target structure 122, while closing the loop with the asset management system 108 as the originator of the inspection request, the recipient of the resulting imagery and sensor data 116, and the holder of information to be used to improve subsequent inspections of the same, or similar, target structures 122.

In various examples, the asset management system 108 may thus hold information on assets to be inspected. In some examples, the asset management system 108 may hold information such as asset ID and corresponding model of the structure to be inspected, as well as defects related information. For example, the defects related information may include requirements for defects identification and a history of detected defects. In some examples, the asset information may include a model of the target structure 122, the characteristics of the defects to be located, and imagery resolution per square unit. In various examples, each asset may have an associated model. For example, one asset with a corresponding model in the asset management system 108 may be the target structure 122. In various examples, the assets may have one or more sub-assets for which models may also exist. As one example, a sub-asset may be a pillar. In some examples, similar sub-assets may be shared by two or more assets. Thus, insights learned about shared sub-assets may be applied between assets in the asset management system 108. In various examples, the imagery resolution may be provided as a Ground Sample Distance (GSD). The GSD in a digital photo is a distance between adjacent pixels' centers, as measured on the ground. In some examples, a simple 2D model may mainly include dimensions of the target structure 122 and a binding to a provided specific location.

In various examples, the asset management system 108 can generate a model of the target structure 122. In some examples, the asset management system 108 can generate the model in an automatic, semi-automatic, or a manual manner. In various examples, the model may have different levels of complexity, starting from simple a bounding box, and followed by a more precise model of the target structure 122. For example, the bounding box may be a cuboid, trapezoid, cylinder, or any other suitable geometric shape. In some examples, more complex models may include the surrounding environment such that more precise flight plans can be created. For example, a complex model may include environmental objects such as trees, signs, buildings, mountains, power lines location in proximity of inspected objects, and any other potential obstacles.

The UAV platform 104 can automatically generate an inspection mission 120 based on the target asset information 120. For example, the inspection mission may include a flight trajectory, points for taking imagery, pose of cameras and other payload at any moment of flight, distance from surface. In various examples, the inspection mission may be generated to address AI requirements. In some examples, the inspection mission may be used for defect identification and tracking of defects in structures, such as bridges and walls. In various examples, the generation of automatic inspection mission from the available information may include the creation of a flight mission. For example, flight mission characteristics may include the path to be traversed by the flight of the UAV 102. In various examples, the path may be described using waypoints joined by segments. For example, the waypoints may be defined by geospatial coordinates and altitude. The flight mission characteristics may also include additional characteristics, such as speed of the flight and camera related settings for obtaining better pictures. In some examples, the automated flight planning based on a model may include, for example, the setting of the camera gimbal angle of a UAV 102 during different parts of the flight to capture the relevant portions of a target structure 122 at a specific location. In various examples, the automated flight planning based on a model may also include producing images in a quality which is high enough to enable good results by the associated AI services 112 further down the processing pipeline. In some examples, generated missions are stored to be used to perform repeated inspection missions for the same target structure 122. For example, the saved missions and the parameters used during such missions may serve as a starting point for generating missions for similar assets. In some examples, the saved missions and their parameters may be used for consistent repetition of the same inspection mission 120 on the same target structure 122 at a later point in time.

In various examples, the UAV platform 104 thus receives target asset information 120 from the asset management system 108 and carries out a requested inspection in an automatic manner. For example, the UAV platform 104 may initiate an automatic UAV task that inspects the whole of the target structure 122, while feeding an AI process of the AI services 112 with information in the form of imagery 116 and corresponding metadata. The metadata may include additional information corresponding to the imagery and sensor data, including UAV location data generated during the flight. In some examples, the metadata may also include the time that the imagery and sensor data was collected, camera pose described using angles in three dimensions of the camera, camera exposure time, aperture, and ISO, among other types of metadata.

In various examples, the UAV platform may send commands 118 to initiate the actual automatic flight of a UAV inspecting the requested structure by taking images while flying close to the target structure 122. Information collected by the UAV 102, such as imagery and sensor data 116, along with corresponding metadata, may be fed into an AI model 114 to identify and locate significant defects in the inspected target structure 122. In some examples, images may be transferred to the AI model 114 may in real-time, while the UAV is in the air. In various examples, images may be transferred to the AI model 114 post mission, after the UAV flight has concluded. Metadata may include information such as the location, to help locate defects and improve AI results in general. In some examples, metadata may also include an asset ID to be able to close the loop with the asset management system 108 and link the findings to the corresponding asset in the system 100, such as the target structure 122.

In various examples, the quality of the produced imagery 116 may enable successful operation of the entire system. Thus, if the quality of the imagery 116 obtained by the system is not high enough, the connected AI model 114 may not succeed in detecting defects on the target structure 122. Therefore, the camera configuration and settings may be automatically set according to the location of the target structure 122 and the model for the target structure 122. In various examples, the bi-directional information sharing via the communication channel 106 enables the AI process to communicate to the UAV platform 104 information that can be used by the UAV platform 104 to capture higher quality images. For example, the information may indicate that a resolution of an image is to be increased, or that an image is to be taken from a different angle or closer to the target structure.

In some examples, the system 100 may use a multi-level analysis approach for improving imagery artifacts and eventually obtaining better results at the associated AI pipelines of the AI services 112. For example, in a first level, while the UAV is flying and taking pictures in real-time, the system 100 can use an onboard computer to perform a first analysis of picture quality to identify possible issues with the pictures being taken. In some examples, the pictures in this first level of analysis may be executed using lower resolution images so that the analysis can be achieved in real-time. Thus, the UAV 102 may perform real-time handling of camera parameters on board based via image processing based improvements of pictures. In various examples, the results of this preliminary onboard analysis, if any, may flow back to the UAV platform 104, for it to take corrective measures immediately, and enhance the corresponding inspection mission.

At a second level of analysis, there may be a bi-directional means of communication between the UAV system, including the UAV platform 104 and the UAV 102, and the AI services 112. For example, the UAV system may feed the AI model 114 with imagery and associated metadata as input, and the AI services 112 may provide feedback to the UAV platform for capturing better images. For example, the feedback may include one or more commands 118 to change location or various parameters.

A third level of analysis may be performed offline using higher resolution pictures. At this stage, feedback may flow back to the UAV platform 104 such that improvements can accordingly be made for subsequent inspections of the same asset.

At a higher level, the AI services 112 can analyze the results that were found, and propose improvements for future flights based on the analyzed results. In various examples, the analysis may be performed by onboard or remote AI services 112. For example, upon the identification of an area with a high concentration of defects, the AI services 112 can propose following inspections of the same asset or inspection of other assets with similar characteristics to pay specific attention to the identified areas that may be problematic as well. Thus, the AI services 112 can learn where problems are found, and apply information in other assets and missions with similar characteristics to a current inspection mission. In various examples, feedback from the AI services 112 can be applied to a model associated with a structure, and thus applied to future inspections or inspections of similar structures.

The AI services 112 in turn can generate an overall representation of the inspected structure 122 by using the individual images 116 provided by the UAV. In addition, the AI services 112 can identify and measure defects, feeding back the defect information to the asset management system 108, and proposing improvements to the inspection mission 120. In turn, the UAV platform 104 can use the feedback information to change the route of the UAV in real-time in order to improve the overall results of AI processing.

Thus, the inspection route and associated characteristics may be calculated by the UAV platform 104 based on AI requirements, for example in terms of resolution of images taken, distance from the inspected structure, ground sample distance, and overlap required between consecutive photos. Properties of the camera to be used for the inspection may be taken into consideration as well to achieve higher quality pictures. For example, camera properties may include focal length in zoom lenses, contrast, brightness and shutter speed. In various examples, external properties may be taken into consideration as well. For example, external properties may include image resolution that may be set be based on anticipated size of the objects to be scanned. In some examples, the camera properties may define the distance required from the object while flying and scanning the target structure 122. In some examples, other properties, such as flight speed while scanning, may be derived based on the feedback from the AI process of the AI services 112, and the characteristics of the camera in the UAV 102. Additional feedback from the AI services 112 to the UAV platform 104 may include properties of the equipment (such as a camera) to be used for a specific inspection mission 120. In some examples, the UAV platform 104 can make temporary parameter modifications associated with temporary conditions. For example, the temporary parameter modifications may include adjustments of the distance the UAV from an inspected surface and zoom in cases of strong winds, adjustment of brightness in cases of changing lighting conditions, among other temporary parameter modifications.

In various examples, the bi-directional interaction between the UAV and the AI services 112 can take place both in real-time and post mission, once the UAV 102 is back on the ground. In real-time, the AI services 112 may provide feedback to improve the imagery 116 provided by the UAV. For example, the UAV platform 104 may send commands 118 to the UAV to change shutter speed based on current lighting conditions to capture higher quality pictures. In some examples, additional real-time feedback may include the location of an identified suspected defect. For example, in response to receiving the location of an identified defect, the UAV 102 can fly back to that location and take further or better pictures by, for example, by flying at a shorter distance from the target structure 122. In some examples, additional feedback from the AI services 112 may include requests to re-focus the camera at specific locations of the target structure 122.

In various examples, some operations may take place before or during a flight. For example, camera re-focus points may be deduced before the actual flight based on retrieving relevant significant locations from the model associated with the target structure 122 to be inspected. In addition, camera re-focus may be performed by following indications from the AI services 112 as to the location and moment in which a re-focus process should take place. In various examples, the corresponding analysis process may take place onboard the UAV 102 or operating externally in real-time. Thus, the system 100 may achieve on-the-fly analytics to obtain better pictures, potentially combining dynamic routing with dynamic camera setting. In some examples, in response to an interaction between the UAV platform 104 and the AI services 112, the UAV may initiate a change in its camera settings, and in addition may change its course while in mid-air to achieve better footage of specific locations. Thus, an automatic camera setting may be based on information collected and analyzed prior to the flight, during the flight by the UAV platform 104 itself, during the flight via indications from the AI services 112, or post-flight to be applied during the following inspection missions of the same asset. For example, such settings may be based on UAV trajectory, lighting conditions, or relative position of the UAV to the target structure 122.

In some examples, post mission information communicated from the AI services 112 can provide valuable information to close the loop with the UAV platform 104 and the asset management system 108. Such feedback may include the use of a camera with certain specifications, while flying at a certain distance from the structure, at a certain speed.

In various examples, the findings by the AI services 112 as well as indications for optimal flight properties for the target structure 122 may be communicated back to the asset management system 108. In some examples, indications for optimal flight properties may be used by UAV Platform 104 for flight path improvements. For example, AI findings that are related to flight path optimization, such as speed, distance from surface, camera parameters may not be transferred to Asset Management system 108, but processed by UAV platform 104. In some examples, improved flight paths can optionally be stored the asset management system 108 and also potentially used in subsequent inspections as a part of target asset information 120. In various examples, the asset management system 108 can then apply findings and optimal flight properties at consecutive inspecting flights of the same target structure 122. This application of previous findings and flight properties may enable the UAV platform 104 to later conduct the same exact inspection mission 120 with nearly 100% accuracy since the entire inspection, along with its exact locations, are automatic and computer calculated. In various examples, in a last stage, findings by the AI services 112 may be communicated back to the UAV platform 104. For example, AI findings that are related to defect identification, may be transferred to asset management system 108 via UAV Platform 104. In various examples, the AI findings related to defect identification may include the area of pixels in the image that contains detected defect, defect type, defect size estimation on surface, and defect location, among other information. For example, a defect location may be relative to surface corners. In some examples, this information may also potentially include the raw information that led to the findings. In various examples, relevant users may receive the AI finding information related to defect identification and may then act upon this information. For example, a team may be sent out to repair a certain defect at a certain location, on a particular structure, such as a bridge. In various examples, suggested characteristics of the flight and camera settings may be communicated as well to the asset management system 108, resulting in inspection characteristics based on AI requirements. For example, the AI services 112 may propose a camera with certain specifications, or flying at a certain distance, or at a certain speed. In some examples, the asset management system 108, upon receiving defect identification information, may in turn locate additional target structures 122 with similar characteristics and apply the proposed measures on these target structures 122 as well. For example, in the case of similar bridges, the generated inspection missions may concentrate on a particular area of the bridges. For example, the AI services 112 may have identified problematic areas in a structure in which there is a concentration of defects.

It is to be understood that the block diagram of FIG. 1 is not intended to indicate that the system 100 is to include all of the components shown in FIG. 1. Rather, the system 100 can include fewer or additional components not illustrated in FIG. 1 (e.g., additional client devices, or additional resource servers, etc.).

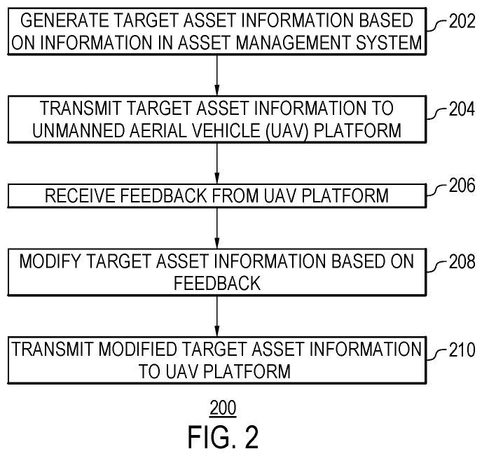

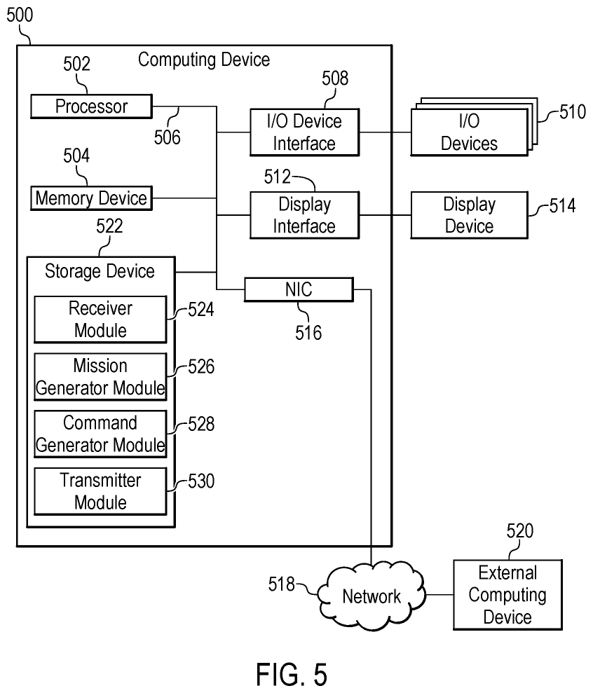

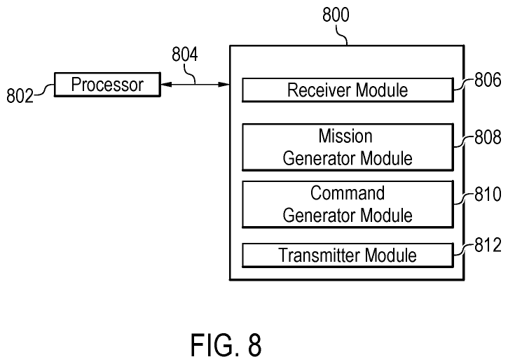

FIG. 2 is a process flow diagram of an example method that can automatically and dynamically inspect structures. The method 200 can be implemented with any suitable computing device, such as the computing device 500 of FIG. 5 and is described with reference to the system 100 of FIG. 1. For example, the method 200 can be implemented by the asset management system 108 of FIG. 1. In various examples, the method 200 can be implemented using the processor 502 or the processor 802 of FIGS. 5 and 8, respectively.

At block 202, a processor generates target asset information based on information in an asset management system. For example, the target asset information may include the geometry and IDs of assets and sub-assets to be inspected, such as a target structure. In some examples, the target asset information may be generated based on artificial intelligence (AI) model requirements. For example, the target asset information may include feedback from previously completed inspection missions. In various examples, the feedback may include camera parameter modifications, route modifications, location or distance modifications, changes in the number of images captured, etc. In some examples, the target asset information may include parameters used in previous inspection missions of the same structure. For example, the same parameters may be used with the same payload on the UAV in order to generate imagery and sensor data that is optimal for a comparison of changes in the structure over time. As one example, one or more cracks in a target structure may evolve over time and an AI model may be provided similar images taken from similar locations and angles at a different time in order to detect any changes in the cracks. Therefore, the inspection mission may be generated using similar parameters as previous missions to be compared.

At block 204, the processor transmits the target asset information to an unmanned aerial vehicle (UAV) platform. For example, the inspection mission may be transmitted to the UAV platform via a wireless communication interface. In various examples, the UAV platform may then generate commands based on the inspection mission. The UAV may then execute the commands to perform one or more actions. For example, the actions may include capturing additional images using different aperture, shutter speed, sensor sensitivity. In some examples, the actions may include displacing the UAV in order to take images from a different location, angle, or along a different route, etc.

At block 206, the processor receives feedback from the UAV platform. For example, feedback may be based on images and sensor data received by an AI services module from the UAV platform. The images and may be of a target structure that was inspected. In various examples, the sensor data may include the location, altitude, speed, among other sensor data captured at the UAV. In various examples, the feedback may be received in response to the completion of an inspection mission.

At block 208, the processor modifies the target asset information based on the feedback. In various examples, the processor can modify the target asset information based on received images and sensor data from a UAV. For example, the images and sensor data may be processed by an AI model, and feedback may be received from the AI model. The processor may then generate updated target asset information based on the feedback. For example, the updated target asset information may include modified geometry, and associated asset IDs, sub-asset IDs of modified assets or sub-assets, and geolocations, or other inspection parameters. As one example, the feedback may include a change in the direction of the camera. For example, a location of the UAV may have been correct, but the direction in which an image was taken may be offset from a target direction of a portion of the structure. In various examples, the processor may execute a post-processing once an inspection mission is completed. In some examples, the post-processing may generate post-flight feedback to be applied to additional inspection missions on the same structure or similar structures. For example, based on asset geometry and defect findings in specific areas of the asset, the processor can change target asset information of similar structures by specifying sensitive areas.

At block 210, the processor transmits the modified target asset information to the UAV platform. In various examples, the modified target asset information may be used to generate an updated inspection mission for a subsequent inspection of the same structure. For example, the updated inspection mission may be transmitted to the UAV after the completion of the inspection mission, the updated inspection mission to inspect a structure for changes with respect to defects detected in the inspection mission. For example, the modified inspection mission may be generated by the UAV platform before the completion of execution of the inspection mission. In some examples, the modified target asset information may be used to inspect similar structures. For example, the modified target asset information may be transmitted to the UAV platform after the completion of an inspection mission, and the modified target asset information may be used to inspect a second structure for defects. For example, the second structure may be similar to the structure inspected in the original inspection mission.

The process flow diagram of FIG. 2 is not intended to indicate that the operations of the method 200 are to be executed in any particular order, or that all of the operations of the method 200 are to be included in every case. For example, in some embodiments, the method 200 may not include receiving feedback at block 206, and subsequent blocks 208 and 210. Additionally, the method 200 can include any suitable number of additional operations.

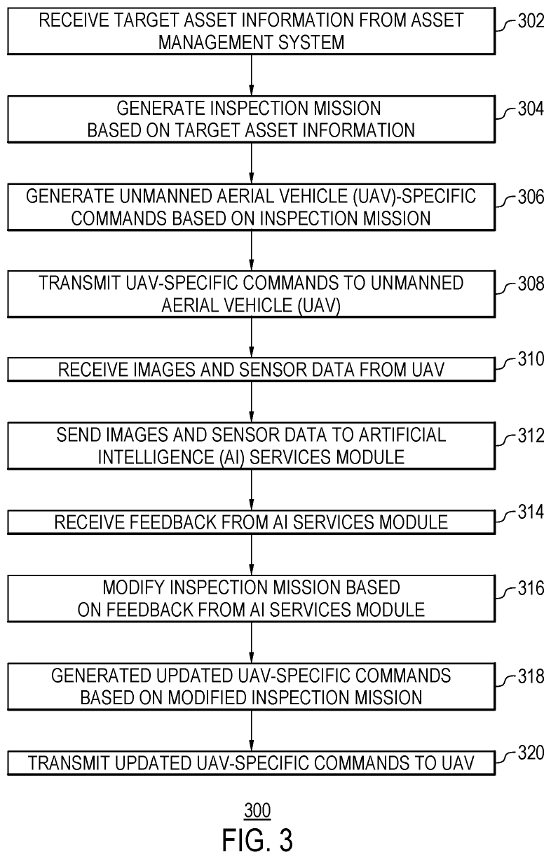

FIG. 3 is a process flow diagram of an example method that can generate commands for an unmanned aerial vehicle (UAV) based on AI feedback. The method 300 can be implemented with any suitable computing device, such as the computing device 500 of FIG. 5 and is described with reference to the system 100 of FIG. 1. For example, the method may be performed via the UAV platform 104 of FIG. 1. In various examples, the method 200 can be implemented using the processor 802 of FIG. 8.

At block 302, the processor receives target asset information from an asset management system. For example, the target asset information may include geometry and IDs of assets and sub-assets for a particular structure to be inspected. In some examples, the target asset information may be based in part on a previous inspection mission. For example, the target asset information may include geometry updated based on feedback received in previous inspection missions. In some examples, the target asset information can be updated with sensitive areas or parts of an asset.

At block 304, the processor generates an inspection mission based on the target asset information. For example, the inspection mission may include UAV-agnostic commands used to complete a particular flight path, commands for capturing images along the flight path, as well as particular waypoints to stop at and take additional images, and means to receive and transfer imagery and other sensor data. In some examples, the UAV-commands may include parameters to be used by a camera capturing the images.

At block 306, the processor generates unmanned aerial vehicle (UAV)-specific commands based on the inspection mission. For example, the UAV-specific commands may be specific to a UAV being used to inspect the target asset.

At block 308, the processor transmits the UAV-specific commands to an unmanned aerial vehicle (UAV). For example, the commands may be UAV-specific commands transmitted via any suitable wireless connection.

At block 310, the processor receives images and sensor data from the UAV. For example, the images and may be of a target structure currently being inspected. In various examples, the images and sensor data may be from a waypoint of the inspection mission or along a segment between two waypoints of the inspection mission. In various examples, the sensor data may include the location, altitude, speed, among other sensor data captured at the UAV.

At block 312, the processor sends the images and sensor data to an artificial intelligence (AI) services module. For example, the AI services module may have any number of machine learning models trained to perform various tasks. In some examples, the AI services module may be located in the UAV platform. In various examples, the processor also sends metadata to the AI services modules. For example, the metadata may include information corresponding to the images and sensor data, such as location, date, time, etc.

At block 314, the processor receives feedback from the AI services module. For example, the feedback may be post-flight feedback. In various examples, the post-flight feedback may include identification of regions of the target structure in which larger number of defects have been detected. In some examples, the post-flight feedback may also include the position of the defect on the surface. For example, the post-flight feedback may include offsets from the surface corners. In various examples, the feedback may be real-time feedback. For example, real-time feedback may be received in real-time during the execution of an inspection mission.

At block 316, the processor modifies the inspection mission based on the feedback from the AI services module. For example, the modified inspection mission may include returning to a particular waypoint to capture additional images. As one example, the additional images may be captured from the different angle, at a different resolution, or a different distance.

At block 318, the processor generates updated UAV-specific commands based on the modified inspection mission. For example, the updated UAV-specific commands may include a modified parameter of a flight path, or a modified parameter of a payload on the UAV. As one example, the updated commands may include a modification of a parameter of a camera on the UAV.

At block 320, the processor transmits updated UAV-specific commands to the UAV. For example, the updated UAV-specific commands may be transmitted to the UAV via a wireless connection. The UAV may then change its flight path, payload functionality, or orientation, accordingly. For example, the UAV may capture additional images from different angles, distances, or with a different depths of focus, sensor sensitivities, shutter speeds, or apertures.

The process flow diagram of FIG. 3 is not intended to indicate that the operations of the method 300 are to be executed in any particular order, or that all of the operations of the method 300 are to be included in every case. Additionally, the method 300 can include any suitable number of additional operations. In various examples, the processor may receive additional images and sensor data from the UAV. For example, the additional images may have been captured by the UAV using updated camera parameters, or from a different angle, or location, such as along a modified route.

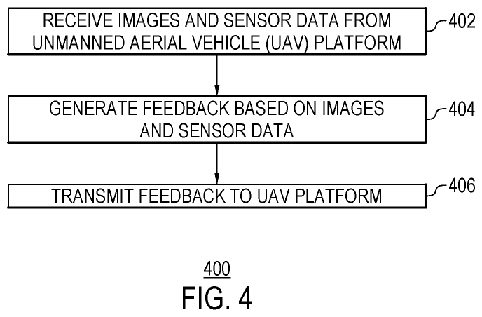

FIG. 4 is a process flow diagram of an example method that can generate feedback based on images and data from a UAV. The method 400 can be implemented with any suitable computing device, such as the computing device 500 of FIG. 5 and is described with reference to the system 100 of FIG. 1. For example, the method may be performed via the UAV platform 104 of FIG. 1. In various examples, the method 200 can be implemented using the processor 802 of FIG. 8.

At block 402, a processor receives images and sensor data from an unmanned aerial vehicle (UAV) platform. For example, the images and sensor data may be associated with a target structure being inspected.

At block 404, the processor generates feedback based on the images and the sensor data. In some examples, the feedback may be real-time feedback that includes one or more parameter adjustments. For example, real-time analytics may be used to generate real-time feedback that combines dynamic routing with dynamic camera setting. Dynamic routing may include controlling an angle to the surface of a target structure, overlap of images taken by the UAV. In various examples, dynamic camera settings may include settings such as brightness, ISO sensitivity, aperture, shutter speed, focus, etc. In some examples, the feedback may be generated after completion of an inspection mission. For example, post-flight feedback may include suggesting the use of a camera with certain specifications, while flying at a certain distance from the structure, at a certain speed.

At block 406, the processor transmits the feedback to the UAV platform. For example, the processor may transmit real-time feedback to the UAV platform to modify one or more parameters of a UAV's flight plan or payloads in order to obtain improved images. In some examples, the processor may transmit post-flight feedback after completion of an inspection mission. For example, findings by the AI services module as well as indications for optimal flight properties for a target structure may be communicated back to the asset management system. In various examples, the post-processing feedback may be used in generating future inspection missions for the same target structure or similar target structures. For example, the post-processing feedback may identify problematic areas in which there is a concentration of defects in the target structure or similar target structures.

The process flow diagram of FIG. 4 is not intended to indicate that the operations of the method 400 are to be executed in any particular order, or that all of the operations of the method 400 are to be included in every case. Additionally, the method 400 can include any suitable number of additional operations.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 5 is block diagram of an example computing device that can generate and modify inspection missions based on AI feedback. The computing device 500 may be for example, a server, desktop computer, laptop computer, tablet computer, or smartphone. In some examples, computing device 500 may be a cloud computing node. Computing device 500 may be described in the general context of computer system executable instructions, such as program modules, being executed by a computer system. Generally, program modules may include routines, programs, objects, components, logic, data structures, and so on that perform particular tasks or implement particular abstract data types. Computing device 500 may be practiced in distributed cloud computing environments where tasks are performed by remote processing devices that are linked through a communications network. In a distributed cloud computing environment, program modules may be located in both local and remote computer system storage media including memory storage devices.

The computing device 500 may include a processor 502 that is to execute stored instructions, a memory device 504 to provide temporary memory space for operations of said instructions during operation. The processor can be a single-core processor, multi-core processor, computing cluster, or any number of other configurations. The memory 504 can include random access memory (RAM), read only memory, flash memory, or any other suitable memory systems.

The processor 502 may be connected through a system interconnect 506 (e.g., PCI®, PCI-Express®, etc.) to an input/output (I/O) device interface 508 adapted to connect the computing device 500 to one or more I/O devices 510. The I/O devices 510 may include, for example, a keyboard and a pointing device, wherein the pointing device may include a touchpad or a touchscreen, among others. The I/O devices 510 may be built-in components of the computing device 500, or may be devices that are externally connected to the computing device 500.

The processor 502 may also be linked through the system interconnect 506 to a display interface 512 adapted to connect the computing device 500 to a display device 514. The display device 514 may include a display screen that is a built-in component of the computing device 500. The display device 514 may also include a computer monitor, television, or projector, among others, that is externally connected to the computing device 500. In addition, a network interface controller (NIC) 516 may be adapted to connect the computing device 500 through the system interconnect 506 to the network 518. In some embodiments, the NIC 516 can transmit data using any suitable interface or protocol, such as the internet small computer system interface, among others. The network 518 may be a cellular network, a radio network, a wide area network (WAN), a local area network (LAN), or the Internet, among others. An external computing device 520 may connect to the computing device 500 through the network 518. In some examples, external computing device 520 may be an external webserver 520. In some examples, external computing device 520 may be a cloud computing node.

The processor 502 may also be linked through the system interconnect 506 to a storage device 522 that can include a hard drive, an optical drive, a USB flash drive, an array of drives, or any combinations thereof. In some examples, the storage device may include a receiver module 524, a mission generator module 526, a command generator module 528, and a transmitter module 530. The receiver module 524 can receive target asset information from an asset management system. The receiver module 524 can receive images and sensor data from a UAV. The receiver module 524 can also receive feedback from an artificial intelligence (AI) services module. For example, the feedback may be generated based on imagery and sensor data from the UAV. In various examples, the feedback from the AI services module is based on an AI service requirement. In some examples, the receiver module 524 can receive both real-time feedback and post-flight feedback from an AI services module. The mission generator module 526 can generate an inspection mission including commands for a target structure based on the target asset information received from an asset management system. For example, the target asset information may include a geometry and asset ID of the target structure. In some examples, the mission generator module 526 can modify the inspection mission based on the feedback from the artificial intelligence services module. In various examples, the mission generator module 526 can generate a second inspection mission for the target structure based on the feedback. In various examples, the mission generator module 526 can generate the inspection mission based on a previously executed inspection mission for a similar target structure. For example, the similarity of the similar target structure may be determined based on a comparison of corresponding models in the information of the asset management system. The command generator module 528 can generate UAV-specific commands based on the inspection mission. The transmitter module 530 can transmit the UAV-specific commands to an unmanned aerial vehicle (UAV) platform. For example, the UAV platform may then dynamically generate updated UAV-specific commands for the UAV based on the inspection mission and the feedback from the AI services module. The transmitter module 530 can send the images and sensor data to an artificial intelligence (AI) services module.

It is to be understood that the block diagram of FIG. 5 is not intended to indicate that the computing device 500 is to include all of the components shown in FIG. 5. Rather, the computing device 500 can include fewer or additional components not illustrated in FIG. 5 (e.g., additional memory components, embedded controllers, modules, additional network interfaces, etc.). Furthermore, any of the functionalities of the receiver module 524, the mission generator module 526, the command generator module 528, and the transmitter module 530 may be partially, or entirely, implemented in hardware and/or in the processor 502. For example, the functionality may be implemented with an application specific integrated circuit, logic implemented in an embedded controller, or in logic implemented in the processor 502, among others. In some embodiments, the functionalities of the receiver module 524, the mission generator module 526, the command generator module 528, and the transmitter module 530 can be implemented with logic, wherein the logic, as referred to herein, can include any suitable hardware (e.g., a processor, among others), software (e.g., an application, among others), firmware, or any suitable combination of hardware, software, and firmware.

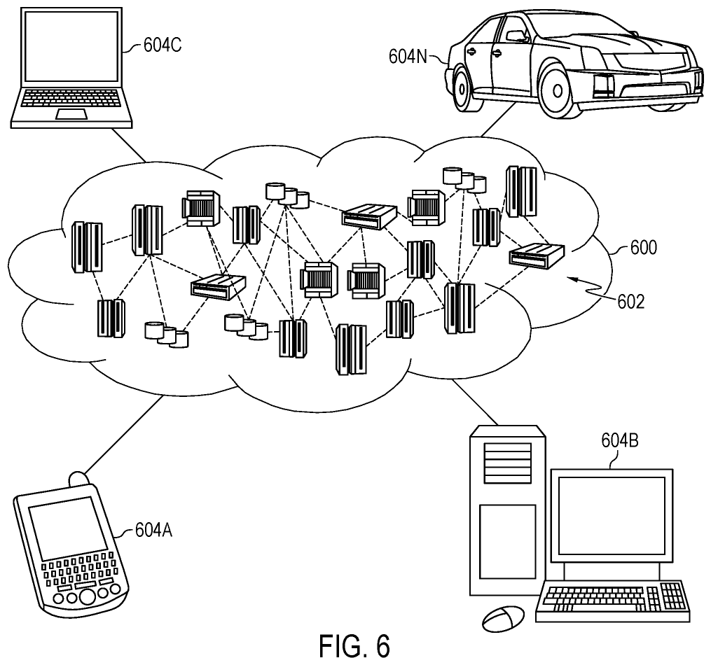

Referring now to FIG. 6, illustrative cloud computing environment 600 is depicted. As shown, cloud computing environment 600 includes one or more cloud computing nodes 602 with which local computing devices used by cloud consumers, such as, for example, personal digital assistant (PDA) or cellular telephone 604A, desktop computer 604B, laptop computer 604C, and/or automobile computer system 604N may communicate. Nodes 602 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 604A-N shown in FIG. 6 are intended to be illustrative only and that computing nodes 602 and cloud computing environment 600 can communicate with any type of computerized device over any type of network and/or network addressable connection (e.g., using a web browser).

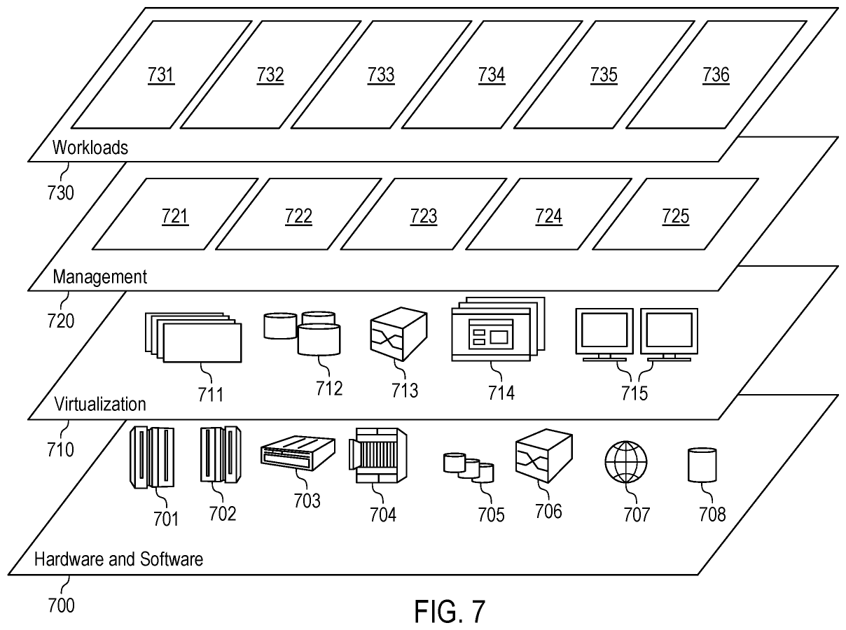

Referring now to FIG. 7, a set of functional abstraction layers provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 700 includes hardware and software components. Examples of hardware components include: mainframes 701; RISC (Reduced Instruction Set Computer) architecture based servers 702; servers 703; blade servers 704; storage devices 705; and networks and networking components 706. In some embodiments, software components include network application server software 707 and database software 708.

Virtualization layer 710 provides an abstraction layer from which the following examples of virtual entities may be provided: virtual servers 711; virtual storage 712; virtual networks 713, including virtual private networks; virtual applications and operating systems 714; and virtual clients 715.

In one example, management layer 720 may provide the functions described below. Resource provisioning 721 provides dynamic procurement of computing resources and other resources that are utilized to perform tasks within the cloud computing environment. Metering and Pricing 722 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 723 provides access to the cloud computing environment for consumers and system administrators. Service level management 724 provides cloud computing resource allocation and management such that required service levels are met. Service Level Agreement (SLA) planning and fulfillment 725 provide pre-arrangement for, and procurement of, cloud computing resources for which a future requirement is anticipated in accordance with an SLA.

Workloads layer 730 provides examples of functionality for which the cloud computing environment may be utilized. Examples of workloads and functions which may be provided from this layer include: mapping and navigation 731; software development and lifecycle management 732; virtual classroom education delivery 733; data analytics processing 734; transaction processing 735; and automated structure inspection 736.

The present invention may be a system, a method and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the techniques. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Referring now to FIG. 8, a block diagram is depicted of an example tangible, non-transitory computer-readable medium 800 that can automatically inspect structures using a UAV with artificial intelligence (AI) feedback. The tangible, non-transitory, computer-readable medium 800 may be accessed by a processor 802 over a computer interconnect 804. Furthermore, the tangible, non-transitory, computer-readable medium 800 may include code to direct the processor 802 to perform the operations of the methods 200-400 of FIGS. 2-4.

The various software components discussed herein may be stored on the tangible, non-transitory, computer-readable medium 800, as indicated in FIG. 8. For example, a receiver module 806 includes code to receive target asset information from an asset management system. In various examples, the target asset information may be based in part on a previous inspection missions. In some examples, the receiver module 806 includes code to receive images and sensor data from an unmanned aerial vehicle (UAV) platform. In some examples, the receiver module 806 includes code to receive feedback from an artificial intelligence (AI) services module. For example, the feedback from the AI services module may be based on an AI services requirement. In some examples, the receiver module 806 includes code to receive the feedback in real-time from the AI services module. In some examples, the receiver module 806 also includes code to receive the feedback at the completion of the inspection mission. For example, the feedback may be post-flight feedback received after completion of the inspection mission. In various examples, post-flight feedback may be used to modify a model corresponding to an asset inspected by the inspect mission. For example, the modified model may be used by the mission generator module 808 to modify the inspection mission. A mission generator module 808 includes code to generate an inspection mission based on information in an asset management system. For example, the commands in the inspection mission may include generic commands. A command generator module 810 includes code to generate UAV-specific commands based on the inspection mission. For example, the command generator module 810 includes code to generate UAV-specific commands used to complete a particular flight path, commands for capturing images along the flight path, as well as particular waypoints to stop at and take additional images. In various examples, the command generator module 810 includes code to generate UAV-specific commands based on generic commands in the inspection mission. A transmitter module 812 includes code to transmit UAV-specific commands to a UAV. In various examples, the transmitter module 812 includes code to transmit updated UAV-specific commands corresponding to modified inspection missions to the UAV. For example, updated UAV-specific commands corresponding to the modified inspection mission may be transmitted to the UAV after the completion of the inspection mission, and the modified inspection mission may inspect a structure for changes with respect to defects detected in the inspection mission. In some examples, the updated UAV-specific commands corresponding to a modified inspection mission may be transmitted to the UAV after the completion of the inspection mission, the modified inspection mission to inspect a second structure for defects. For example, the second structure may be similar to a structure inspected in the inspection mission. In some examples, the transmitter module 812 includes code to send updated UAV-specific commands based on AI feedback to the UAV during an inspection mission.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. It is to be understood that any number of additional software components not shown in FIG. 8 may be included within the tangible, non-transitory, computer-readable medium 800, depending on the specific application.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
receive target asset information from an asset management system;
generate an inspection mission based on the target asset information;
generate unmanned aerial vehicle (UAV)-specific commands based on the inspection mission;
transmit the UAV-specific commands to an unmanned aerial vehicle (UAV) platform;
receive images and sensor data from the UAV;
send the images and sensor data to an artificial intelligence (AI) services module;
receive feedback from the AI services module; and
modify the inspection mission based on the feedback.

2. The system of claim 1, wherein the processor is to receive both real-time feedback and post-flight feedback from the AI services module.

3. The system of claim 1, wherein the target asset information comprises a geometry and asset ID of the target structure.

4. The system of claim 1, wherein the processor is to generate a second inspection mission for the target structure based on the feedback.

5. The system of claim 1, wherein the feedback from the AI services module is based on an AI services requirement.

6. The system of claim 1, wherein the processor is to generate the inspection mission based on a previously executed inspection mission for a similar target structure, wherein the similarity of the similar target structure is determined based on a comparison of corresponding models in the information of the asset management system.

7. The system of claim 1, wherein the UAV platform is to dynamically generate updated commands for the UAV based on the inspection mission and the feedback from the AI services module.

8. A computer-implemented method, comprising:
receiving, via a processor, target asset information from an asset management system;
generating, via the processor, an inspection mission comprising commands for a target structure based on the target asset information;
transmitting, via the processor, the UAV-specific commands to an unmanned aerial vehicle (UAV) platform;
receiving, via the processor, images and sensor data from the UAV;
sending, via the processor, the images and sensor data to an artificial intelligence (AI) services module;
receiving, via the processor, feedback from the AI services module; and
modifying, via the processor, the inspection mission to generate updated commands based on the feedback.

9. The computer-implemented method of claim 8, comprising transmitting, via the processor, the updated commands to the UAV.

10. The computer-implemented method of claim 9, wherein the target asset information is based in part on a previous inspection mission.

11. The computer-implemented method of claim 9, wherein the feedback comprises post-flight feedback received after completion of the inspection mission.

12. The computer-implemented method of claim 8, comprising receiving, via the processor, the feedback in real-time from an AI services module and sending the updated commands to the UAV during the inspection mission.

13. The computer-implemented method of claim 8, wherein the feedback comprises real-time feedback received during the inspection mission.

14. The computer-implemented method of claim 8, wherein the feedback from the AI services module is based on an AI services requirement.

15. A computer program product for inspecting structures, the computer program product comprising a computer-readable storage medium having program code embodied therewith, wherein the computer-readable storage medium is not a transitory signal per se, the program code executable by a processor to cause the processor to:
receive target asset information from an asset management system;
generate an inspection mission based on the target asset information;
generate unmanned aerial vehicle (UAV)-specific commands based on the inspection mission;
transmit the UAV-specific commands to an unmanned aerial vehicle (UAV) platform;
receive images and sensor data from the UAV;
send the images and sensor data to an artificial intelligence (AI) services module;
receive feedback from AI services module; and
modify the inspection mission based on the feedback.

16. The computer program product of claim 15, further comprising program code executable by the processor to transmit commands corresponding to the modified inspection mission to the UAV.

17. The computer program product of claim 16, wherein the feedback comprises post-flight feedback received after completion of the inspection mission.

18. The computer program product of claim 16, wherein the target asset information is based in part on a previous inspection mission.

19. The computer program product of claim 15, further comprising program code executable by the processor to receive the feedback in real-time from an AI services module and send the updated commands to the UAV during the inspection mission.

20. The computer program product of claim 15, wherein the feedback from the AI services module is based on an AI services requirement.
